(19) United States
(12) Patent Application Publication
(10) Pub. No.: US 2002/0000741 A1
(43) Pub. Date: Jan. 3, 2002

(54) Portable, convertible seat, lounge chair and sleeping mat

(76) Inventors: Candace W. Clay, Lexington, KY (US); Marcheta F. Pennington, Lexington, KY (US)

Correspondence Address: Candace W. Clay, 240 Cochran Rd., Lexington, KY, 40502, US

(21) Appl. No.: 09/794,438

(22) Filed: Feb. 27, 2001

Related U.S. Application Data
(60) Provisional application No. 60/185,313, filed on Feb. 28, 2000.

(51) Int. Cl. B60N 2/32; A47C 13/00

(52) U.S. Cl. 297/118

(57) ABSTRACT

A lightweight, portable sitting support for infants that provides back and side support for infants that can hold their heads up well and sit up for some amount of time unassisted but that do not yet have the skills to remain in a seated position without back and side support which is structurally sturdy and does not rely for stability on its own mass and weight or on the mass and weight or balance of the individual using it and which also has other applications during the child's infancy and as the child grows including as a lightweight, portable sleeping mat, chair and lounge chair. The base of the invention is a substantially rectangular-shaped, thinly padded base made of strong fabric such as nylon. Extending from the base are four cushions and four flaps with buckles. Two parallelepiped substantially rectangular-shaped cushions of the same width as the base extend horizontally over the base beginning at one of the base's horizontal edges and cover approximately two-thirds of the surface area of the base. At the opposite horizontal edge of the base, two parallelepiped substantially square cushions extend vertically at approximately right angles to the base. The seat of the invention is formed by the uncovered portion of the base lying between the two vertical cushions. Two flaps with buckles extend from the opposing longitudinal sides of the seat portion of the base. Two additional flaps with buckles extend from the opposing longitudinal sides of the base behind the lower of the two substantially rectangular-shaped cushions extending horizontally over the base. The invention also includes two parallelepiped unattached cushions of the same width and length as the seat. By buckling or unbuckling the flaps, changing the position of the invention, and/or placing the unattached cushion(s) in the seat, the invention variously forms the infant sitting support, infant and child sleeping mat, and child chair and lounge chair described.

### I. BACKGROUND—Field of Invention

This invention relates in general to seats for infants that can hold their heads up well and sit up for some amount of time unassisted but that do not yet have the skills to remain in a seated position without back and side support and, specifically, to such seats for infants that also convert to a sleeping mat for infants and older children and to a chair and lounge chair for older children.

### II. BACKGROUND—Description of Prior Art

Beginning at approximately four to five months of age, an infant can hold his or her head up well and can sit up for some amount of time unassisted but, without back and side support, will eventually topple backward or to one side. It is important during this stage that the infant be able to remain in a seated position for some amount of time in order to build the muscles and gain the skills necessary to achieve and maintain a sitting position without support. Likewise, it is important to the child's mental development during this stage that the child be able to remain in positions other than a prone position so as to receive a variety of visual perspectives. During this stage of an infant's development, parents or caretakers often place cushions to either side and the back of an infant when in the sitting position in order to prevent the baby from falling over.

Devices intended to provide back and side support to infants at the stage of development described have been invented. U.S. Pat. No. 5,005,902 discloses an example of such an infant supporting device. Prior devices such as that disclosed in U.S. Pat. No. 5,005,902, however, have limited application often useful only during the several months of a child's infancy during which the infant can hold his or her head up and maintain a seated position for some amount of time unassisted but cannot yet maintain a sitting position without back and side support.

In addition, from the age that children master the skill of sitting up through their early school years, children are often more comfortable in furniture designed specifically for their use, with proportionately smaller dimensions than chairs designed for adults. Because such children do not spend all or even a majority of their time in their own rooms but instead are just as frequently found in the television room, at dayschool and at the homes of grandparents and other relatives, for maximum utility, furniture designed for children should also be portable. Moreover, a child's comfort and security when away from home is often increased when the child has a familiar object from home with him or her. A child's chair that is portable will increase the child's comfort and security when at daycare, at a relative's house for the weekend or in other situations outside of the child's house.

Thus, a need exists for a portable infant seat which will provide back and side support for infants that can hold their heads up well and sit up for some amount of time unassisted but that do not yet have the skills to remain in a seated position without back and side support and that also has other applications during the child's infancy including as a sleeping mat as well as other applications as the child grows including as a lightweight, portable chair, lounge chair and sleeping mat for older children.

Various forms of convertible furniture have been designed such as the disclosures in U.S. Pat. No. 4,518,203; U.S. Pat. No. 3,902,759; and U.S. Des. 252,489. However, such disclosures cannot serve as a sitting support for infants because such disclosures lack a seat that is substantially level with the ground, a necessary element to allow an infant to maintain balance in a seated position; or because they do not provide side support. Moreover, disclosures such as that U.S. Pat. No. 3,902,759 are not lightweight so as to be easily transportable by adult and child but instead are designed to rely on their mass and weight for stability. Other prior disclosures such as that in U.S. Pat. No. 4,518,203 rely for stability on the mass, weight and balancing skills of the individual using the furniture and, accordingly, are unsuitable for lightweight infants or small children who can be expected to be restless and change positions often while seated or lounging in furniture. In addition, prior disclosures such as that in U.S. Pat. No. 4,518,203 which rely for operation and convertibility on exposed straps are less comfortable and less sturdy especially for young children than furniture that includes arms for side support. Finally, disclosures such as that in U.S. Pat. No. 4,518,203 which rely for operation and convertability on exposed straps or which consist of soft cushions that conform to the shape of the individual using them also likely pose a safety hazard for small infants and children.

### III. OBJECTS

One object of the present invention is to provide a lightweight, portable infant seat which will provide back and side support to infants that can hold their heads up well and sit up for some amount of time unassisted but that do not yet have the skills to remain in a seated position without back and side support.

A second object of the present invention is to provide a lightweight, portable sleeping mat for infants.

A third object of the present invention is to provide a lightweight, portable chair for children for use from the time a child has mastered the skill of sitting up on his or her own through early school age.

A fourth object of the present invention is to provide a lightweight, portable sleeping mat for children for use from the time a child has mastered the skill of sitting up on his or her own through early school age.

A fifth object of the present invention is to provide a lightweight, portable lounge chair for children for use from the time a child has mastered the skill of sitting up on his or her own through early school age.

A sixth object of the present invention is to provide an infant seat which will provide back and side support for infants that can hold their heads up well and sit up for some amount of time unassisted but that do not yet have the skills to remain in a seated position without back and side support that is easily converted to a sleeping mat for infants and older children and to a child's chair and lounge chair in accordance with the preceding objects.

A seventh object of the present invention is to provide an infant seat as described in the preceding objects that is convertible to a sleeping mat for infants and older children and to a child's chair and lounge chair in accordance with the preceding objects that is also lightweight so as to be easily transportable.

An eighth object of the present invention is to provide a lightweight, portable infant seat as described in the preceding objects that is convertible to a sleeping mat for infants and older children and to a child's chair and lounge chair in accordance with the preceding objects and that is also structurally sturdy and does not rely for stability on its own mass and weight or on the mass and weight or balance of the individual using it.

A ninth object of the present invention is to provide a lightweight, portable infant seat as described in the preceding objects that is convertible to a sleeping mat for infants and older children and to a child's chair and lounge chair in accordance with the preceding objects that can also be manufactured easily and economically in conformance with conventional forms of manufacturing.

A tenth object of the present invention is to provide a lightweight, portable infant seat as described in the preceding objects that is convertible to a sleeping mat for infants and older children and to a child's chair and lounge chair in accordance with the preceding objects that is also easy for parents and children to use.

An eleventh object of the present invention is to provide a lightweight, portable infant seat as described in the preceding objects that is convertible to a sleeping mat for infants and older children and to a child's chair and lounge chair in accordance with the preceding objects that is long-lasting and substantially trouble-free in operation.

A twelfth object of the present invention is to provide a lightweight, portable infant seat as described in the preceding objects that is convertible to a sleeping mat for infants and older children and to a child's chair and lounge chair in accordance with the preceding objects that does not consist of a soft cushion or rely for operation and convertibility on exposed straps.

Further objects and advantages of the present invention will become a apparent from the following description and drawings.

### IV. DRAWING FIGURES

FIG. 1 is a lateral view of the bottom of the base of the present invention.

FIG. 2 is a perspective view of the present invention positioned in the sleeping mat position.

FIG. 3 is a perspective view of the present invention in the infant sitting support position.

FIG. 4 is a perspective view of the present invention illustrating the base of the invention in the child's lounge chair position and illustrating the back slats and seat slats.

FIG. 5 is a fragmentary perspective view of the present invention illustrating the left back flap with buckle and left seat flap with buckle.

FIG. 6 is a fragmentary perspective view of the present invention illustrating the right back flap with buckle and right seat flap with buckle.

FIG. 7 is a perspective view of the present invention in the child's chair position.

FIG. 8 is a perspective view of the present invention in the child's lounge chair position.

### V. REFERENCE NUMERALS

| | |
|---|---|
| 10 | Base |
| 10A | Seat |
| 12 | Upper back/mat cushion |
| 14 | Lower back/mat cushion |
| 18 | Left back slat |
| 20 | Right back slat |
| 22 | Left seat slat |
| 24 | Right seat slat |
| 26 | Left side member cushion |
| 28 | Right side member cushion |
| 30 | Left back flap with buckle |
| 32 | Right back flap with buckle |
| 34 | Left seat flap with buckle |
| 36 | Right seat flap with buckle |
| 38 | Unattached cushion |
| 40 | Unattached cushion |
| 42 | Handle |

### VI. DESCRIPTION OF INVENTION

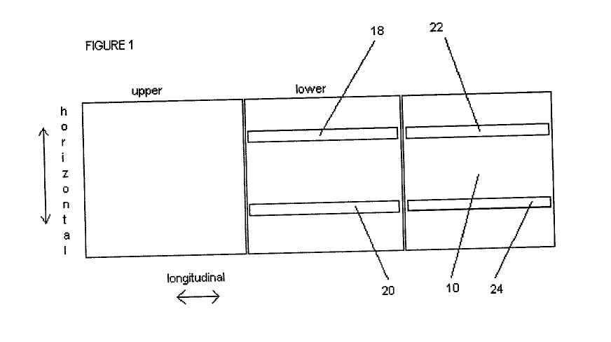

FIG. 1 is a lateral view of the bottom of base 10 of the present invention. Base 10 is a substantially rectangular-shaped, thinly padded base made of strong fabric such as nylon.

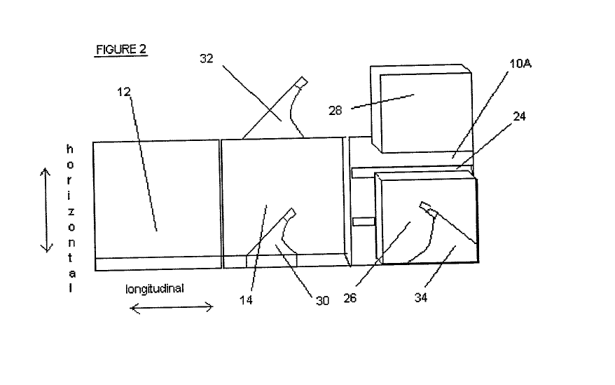

FIG. 2 is a perspective view of the present invention with base 10 extended on a horizontal plane surface. Upper back/mat cushion 12 and lower back/mat cushion 14 are parallelepiped substantially rectangular-shaped cushions each of which is approximately three inches thick and of substantially the same width as base 10. Upper back/mat cushion 12 and lower back/mat cushion 14 consist of a firm cushion made of material such as polyurethane. The exposed faces of upper back/mat cushion 12 and lower back/mat cushion 14 may be covered in any fabric.

As illustrated in FIG. 2, upper back/mat cushion 12 is positioned horizontally over base 10 so that its two parallel faces with the largest surface areas face base 10 and upwardly, respectively, and so that the upper horizontal edge of base 10 and one of the horizontal edges of back/mat cushion 12 coincide. Upper back/mat cushion 12 is attached to base 10 as by longitudinal seams running along the longitudinal edges of cushion 12 and of base 10 and by a horizontal seam running along the upper horizontal edge of base 10 and the coinciding horizontal edge of upper back/mat cushion 12.

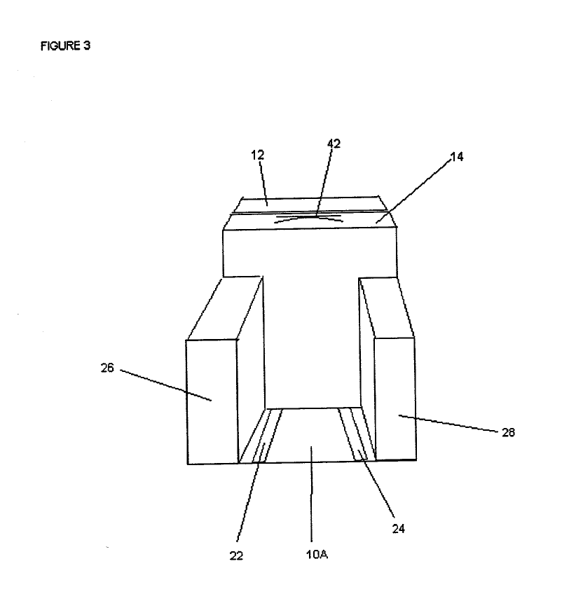

Lower back/mat cushion 14 is positioned horizontally over base 10 in the same manner as and directly adjacent to upper back/mat cushion 12 so that one of the four faces of the upper back/mat cushion 12 with the smallest surface area confronts one of the four faces of lower back/mat cushion 14 with the smallest surface area. Lower back/mat cushion 14 is attached to base 10 as by longitudinal seams running along the longitudinal edges of cushion 14 and of base 10 and by a horizontal seam running along the lower horizontal edge of lower back/mat cushion 14. A handle 42 is attached to the face of lower back/mat cushion 14 confronting the face of upper back/mat cushion 12 as illustrated in FIG. 3.

Left side member 26 and right side member 28 are two parallelepiped cushions made of firm material such as polyurethane. The exposed sides of left side member 26 and right side member 28 may be covered in any fabric. Left side member 26 and right side member 28 extend vertically at approximately right angles to base 10 and are positioned at the lower horizontal edge of base 10, opposite of the horizontal edge to which upper back/mat cushion 12 is attached.

Left side member 26 is attached to base 10 as by a longitudinal seam running along the left longitudinal edge of base 10 and by longitudinal seam running along the right longitudinal side of left side member 26. Left side member 26 may also be attached to base 10 by horizontal seams extending the thickness of the cushion on both of the cushion's horizontal edges.

Right side member 28 extends vertically from the right longitudinal side of base 10 and is attached to base 10 as by a longitudinal seam running along the right longitudinal edge of base 10 and by a longitudinal seam running along the left longitudinal side of right side member 28. Right side member 28 may also be attached to base 10 by horizontal seams extending the thickness of the cushion on both of its horizontal edges.

Seat 10A is formed by the uncovered portion of the base 10 lying between left side member 26 and right side member 28 as illustrated in FIG. 2 and FIG. 3.

The width of upper back/mat cushions 12 and lower back/mat 14 should equal the sum of the width of seat 10A and the thickness of left side member 26 and right side member 28.

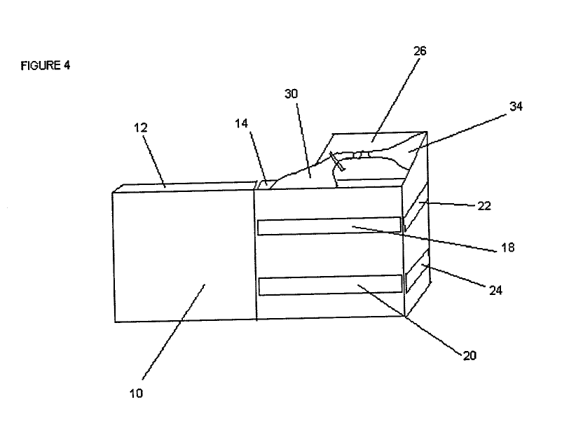

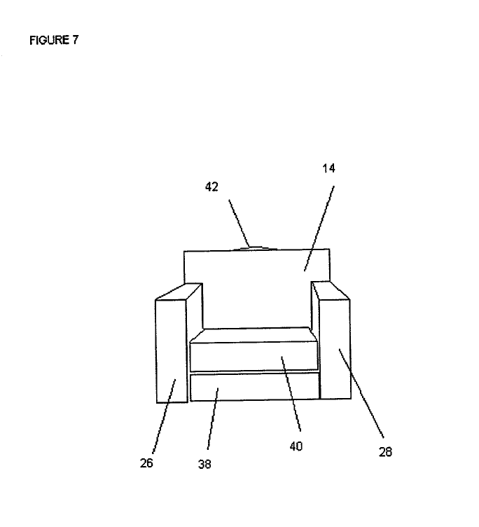

Left back slat 18 and right back slat 20 are made of aluminum or other lightweight, sturdy material. Left back slat 18 and right back slat 20 may be padded as by sewing them into a padded nylon pocket to prevent them from ripping base 10. Left back slats 18 and right back slat 20 are encased inside base 10 behind lower back/mat cushion 14 equidistant from each longitudinal edge of base 10. Left back slat 18 and right back slat 20 and their placement inside base 10 are best illustrated in FIG. 1 and FIG. 4. Left back slat 18 and right back slat 20 should each measure approximately one and one-half inches in width and extend the length of lower back/mat cushion 14 in order to provide support and stability to the invention when in the infant sitting support position illustrated in FIG. 3 and when in the child's chair position illustrated in FIG. 7. The stability provided by left back slat 18 and right back slat 20 are especially important for furniture made for restless infants and children who change positions often.

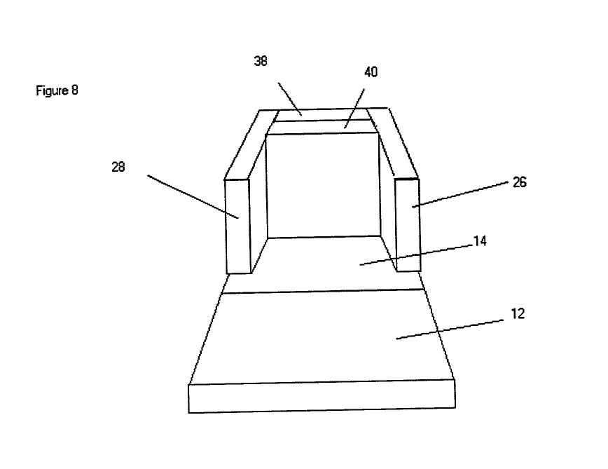

Left seat slat 22 and right seat slat 24 are also made of aluminum or other lightweight sturdy material. As with left back slat 18 and right back slat 20, left seat slat 22 and right seat slat 24 may be encased inside padded nylon pockets to cushion the slats and prevent ripping of the nylon seat 10A. Left seat slat 22 and right seat slat 24 are encased in seat 10A equidistant from each longitudinal edge of seat 10A and at the same distance as left back slat 18 and right back slat 20 are placed from the longitudinal edges of cushion 14. Left seat slat 22 and right seat slat 24 and their placement inside base 10 are best illustrated in FIG. 1 and FIG. 3. Left seat slat 22 and right seat slat 24 should each measure approximately one and one-half inches in width and extend the length of seat 10A to prevent the seat from creasing or folding when in the infant sitting support position and the child's chair position and to add back support and stability when the invention is in the child's lounge chair position as illustrated in FIG. 8.

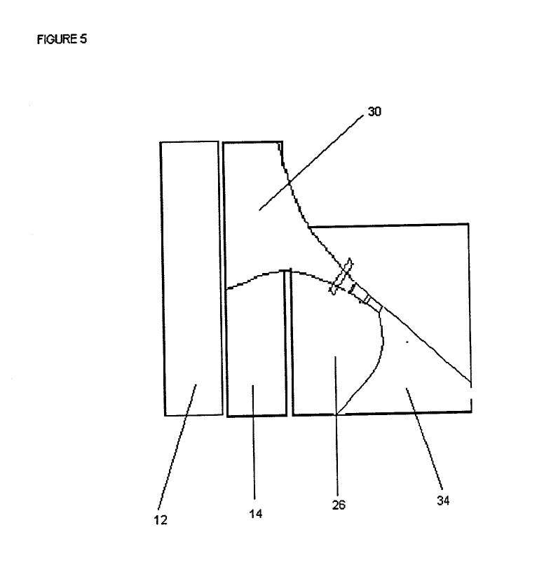

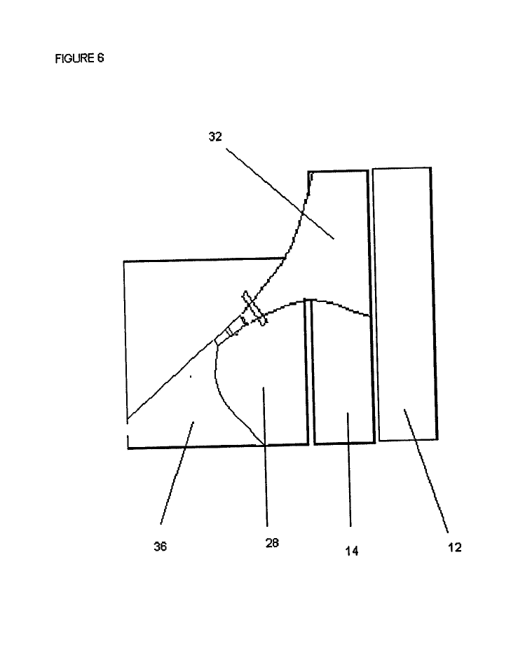

Left back flap 30 extends from the left longitudinal edge of base 10 behind lower back/mat cushion 14 so that the top of left back flap 30 is positioned near the top of lower back/mat cushion 14 when the invention is in the infant seat position. Right back flap 32 extends from the right longitudinal edge of base 10 behind cushion 14 so that the top of right back flap 32 is positioned near the top of cushion 14 when the invention is in the infant seat position. A strap which is approximately two inches in length extends from the bottom of left back flap 30 and right back flap 32. A prong element of a quick-connect buckle is attached to the strap on both flaps as by looping the strap through an aperture in the prong element. Left back flap 30 with strap and buckle is best illustrated in FIG. 5. Right back flap 32 with strap and buckle is best illustrated in FIG. 6.

The bottom of left back flap 30 with the strap and buckle attached extends downward along the left side of left side member 26 when the invention is in the infant seat position. The bottom of right back flap 32 with the strap and buckle attached extends downward along the right side of right side member 28 when the invention is in the infant seat position. Left back flap 30 and right back flap 32 may be cut from the fabric constituting the base or may be attached to the base as by longitudinal seams running along longitudinal edges of base 10 and lower back/mat cushion 14 and by horizontal seams running along the top and bottom horizontal edges of each flap and across the left and right parallel faces of lower back/mat cushion 14.

Left seat flap 34 extends from the left longitudinal side of seat 10A at the lower horizontal edge of base 10, the horizontal edge opposite of that from which upper back/mat cushion 12 extends. Right seat flap 36 extends from the right longitudinal side of seat 10A also at the lower horizontal edge of base 10. Left seat flap 34 and right seat flap 36 are approximately triangular in shape and may be cut from the fabric constituting the base 10 or may be attached to the base 10 as by longitudinal seams running along the left and right longitudinal edges of seat 10A. Left seat flap 34 and right seat flap 36 are attached to the outward sides of the side members as by vertical seams running along the two vertical sides of each of the seat flaps and across the side members.

A strap which is approximately two inches in length extends upward from the narrow angle of the left seat flap 34 and from the narrow angle of the right seat flap 36. A socket element of the quick-connect buckle is attached to the strap as by looping the strap through an aperture in the socket element. Left seat flap 34 with strap and buckle is best illustrated in FIG. 5. Right seat flap 36 with strap and buckle is best illustrated in FIG. 6. When the invention is in the infant seat position, the top of left seat flap 34 with the strap and socket element of the buckle attached extends upward toward the bottom of left back flap 30 with the strap and prong element of the buckle attached. When the invention is in the infant seat position, the top of right seat flap 36 with the strap and socket element of the buckle attached extends upward toward the bottom of right back flap 32 with the strap and prong element of the buckle attached.

Unattached cushion 38 and unattached cushion 40 are parallelepiped cushions of the same length and width as seat 10A. Unattached cushion 38 and unattached cushion 40 consist of a firm cushion made of material such as polyurethane and covered in any fabric.

### VII. OPERATION

When the present invention is positioned with base 10 extended on a horizontal plane surface with upper back/mat cushion 12 and lower back/mat cushion 14 attached as described above and facing upwardly, the structure forms a sleeping mat for infants and small children as illustrated in FIG. 2. Unattached cushion 38 and/or unattached cushion 40 may be placed in the seat 10A to form a head rest for older children.

When the structure is in the sleeping mat position, it may be transformed into the infant seat position as illustrated in FIG. 3 by buckling the prong element of left back flap 30 into the socket element of left seat flap 34 and the prong element of right back flap 32 into the socket element of right seat flap 36. When the flaps are buckled as described, upper back/mat cushion 12 and lower back/mat cushion 14 are pulled up to a vertical position with their bottom faces confronting and form a thick back cushion support for the invention in the infant seat position. Left side member 26 and right side member 28 form thick side support. The infant's back should be against lower back/mat cushion 14 and the infant's bottom should be positioned in seat 10A with legs protruded toward the front of the chair.

The invention forms a child's chair as depicted in FIG. 7 when unattached cushion 38 and/or unattached cushion 40 is/are placed in the seat 10A when the invention is in the infant seat position. As in the infant seat position, upper back/mat cushion 12 and lower back/mat cushion 14 provide thick back support and left side member 26 and right side member 28 serve as side support and the arms of the chair.

A child's lounge chair as depicted in FIG. 8 is formed by buckling the left seat flap 34 to the left back flap 30 and buckling the right seat flap 36 to the right back flap 32 as described above and positioning the invention so that seat 10A with cushions 38 and/or 40 placed in it forms thick cushioned back support for the lounge chair and left side member 26 and right side member 28 form the arms of the lounge chair.

### VIII. CONCLUSION, RAMIFICATIONS and SCOPE

Thus, the invention provides a lightweight, portable sitting support for infants that can hold their heads up well and sit up for some amount of time unassisted but that do not yet have the skills to remain in a seated position without back and side support which does not rely on its own mass and weight for stability or on the mass and weight of the individual using it; said support also converting to a sleeping mat for infants and older children and to a chair and lounge chair for use by children once they have mastered the skill of sitting up through their early school years.

While the above description contains many specificities, these should not be construed as limitations on the scope of the invention but rather as an exemplification of one preferred embodiment thereof.

What is claimed is:

1. A lightweight, portable seat with back and side support said seat also converting to a sleeping mat and reclining lounge chair, comprising:
a) a rectangular-shaped thinly padded base comprising strong fabric and two flaps extending from its opposing longitudinal sides at one horizontal end of the base and two flaps extending from its opposing longitudinal sides at approximately its longitudinal midpoint said flaps including a means of buckling together the two flaps extending from the same longitudinal sides of the base;
b) a plurality of parallelepiped firm cushions each of substantially the same width as the base and made of firm material such as polyurethane and covered in any fabric and each having means for attachment to said base;
c) the first of said parallepiped cushions being attached to the base at one of the base's horizontal edges so that the horizontal edge of the base and the horizontal edge of the cushion coincide and so that one of the cushion's two parallel faces with the largest surface area faces the base;
d) the remainder of said parallepiped cushions being attached to the base beginning directly adjacent to the first and in the same manner as the first so that the cushions' horizontal edges of the same width as the base confront each other;
e) two smaller parallelepiped firm cushions made of the same material as the first set of cushions each having means of attachment to the base;
f) said two smaller parallelepiped cushions being attached to the base at the opposite horizontal edge as the larger cushions so that one of each of the smaller cushion's four faces with the smallest surface area faces the base and so that the cushions extend vertically from the base at approximately right angles to the base;
g) a seat that is substantially level with the ground formed by the portion of the base between the two smaller parallelepiped cushions extending vertically from both longitudinal sides of the base at approximately right angles to the base; and
h) a plurality of additional unattached parallelepiped cushions of the same width and length as the seat.

2. The seat of claim 1 wherein said base is made of nylon.

3. The seat of claim 1 wherein said cushions are made of polyurethane.

4. The seat of claim 1 wherein said cushions that are attached to the base are so attached by seams.

5. The seat of claim 1 further including two slats made of aluminum or other lightweight, sturdy material which are of substantially the same length as the larger cushions attached to the base and are encased inside the base equidistant from its longitudinal sides and behind the larger cushion that is attached to the base at the point nearest the seat;

6. The seat of claim 1 further including two slats made of aluminum or other lightweight, sturdy material which are of substantially the same length as the seat and are encased inside the seat portion of the base equidistant from its longitudinal sides.

7. A lightweight, portable sitting support for infants with back and side support said sitting support also converting to a chair for older children, a sleeping mat for infants and older children and a reclining lounge chair for older children, comprising:
a) a rectangular-shaped thinly padded base comprising strong fabric and two flaps extending from its opposing longitudinal sides at one horizontal end of the base and two flaps extending from its opposing longitudinal sides at approximately its longitudinal midpoint said flaps including a means of buckling together the two flaps extending from the same longitudinal sides of the base;
b) a plurality of parallelepiped firm cushions each of substantially the same width as the base and made of firm material such as polyurethane and covered in any fabric and each having means for attachment to said base;
c) the first of said parallepiped cushions being attached to the base at one of the base's horizontal edges so that the horizontal edge of the base and the horizontal edge of the cushion coincide and so that one of the cushion's two parallel faces with the largest surface area faces the base;
d) the remainder of said parallepiped cushions being attached to the base beginning directly adjacent to the first and in the same manner as the first so that the cushions' horizontal edges of the same width as the base confront each other;
e) two smaller parallelepiped firm cushions made of the same material as the first set of cushions each having means of attachment to the base;
f) said two smaller parallelepiped cushions being attached to the base at the opposite horizontal edge as the larger cushions so that one of each of the smaller cushion's four faces with the smallest surface area faces the base and so that the cushions extend vertically from the base at approximately right angles to the base;
g) a seat that is substantially level with the ground formed by the portion of the base between the two smaller parallelepiped cushions extending vertically from both longitudinal sides of the base at approximately right angles to the base; and
h) a plurality of additional unattached parallelepiped cushions of the same width and length as the seat.

8. The sitting support of claim 7 wherein said base is made of nylon.

9. The sitting support of claim 7 wherein said cushions are made of polyurethane.

10. The sitting support of claim 7 wherein said cushions that are attached to the base are so attached by seams.

11. The sitting support of claim 7 further including two slats made of aluminum or other lightweight, sturdy material which are of substantially the same length as the larger cushions attached to the base and are encased inside the base equidistant from its longitudinal sides and behind the larger cushion that is attached to the base at the point nearest the seat;

12. The sitting support of claim 7 further including two slats made of aluminum or other lightweight, sturdy material which are of substantially the same length as the seat and are encased inside the seat portion of the base equidistant from its longitudinal sides.
